(19) United States
(12) Patent Application Publication
(10) Pub. No.: US 2026/0329558 A1
(43) Pub. Date: Oct. 22, 2026

(54) USER INTERFACE CODE GENERATION

(71) Applicant: Apple Inc., Cupertino, CA (US)

(72) Inventors: Jon-Tait Beason, Shoreline, WA (US); Eldon K. Schoop, Seattle, WA (US); Jeffrey W. Nichols, San Diego, CA (US); Ruijia Cheng, Bellevue, WA (US)

(21) Appl. No.: 19/653,460

(22) Filed: Apr. 21, 2026

Related U.S. Application Data
(60) Provisional application No. 63/792,821, filed on Apr. 22, 2025.

(51) Int. Cl. G06F 8/38; G06F 11/3668; G06T 11/60

(52) U.S. Cl. CPC G06F 8/38; G06F 11/3668; G06T 11/60; G06T 2200/24

(57) ABSTRACT

Methods, systems, and apparatus, including computer programs encoded on computer storage media, for generating code for software applications. One of the methods includes causing presentation, in a development user interface, of at least some of the plurality of intermediate elements that include: a) a navigation flow wireframe; b) a data model; and c) a user interface skeleton that was generated using a navigation flow plan; receiving, via the development user interface of the development system, input data that causes a change to at least one intermediate element from the plurality of intermediate elements; updating, using the input data, the intermediate element from the plurality of intermediate elements; and after updating the intermediate element, causing generation of at least a portion of software code for the application using the navigation flow plan and the plurality of intermediate elements including the updated intermediate element.

### CROSS-REFERENCE TO RELATED APPLICATION

This application claims the benefit of U.S. Provisional Application No. 63/792,821, filed Apr. 22, 2025, the contents of which are incorporated by reference herein.

### BACKGROUND

Large Language Models (“LLMs”) can be used for a wide variety of tasks. Sometimes, developers can use LLMs to generate code.

### SUMMARY

In general, one aspect of the subject matter described in this specification can be embodied in methods that include the actions of causing presentation, in a development user interface, of at least some of the plurality of intermediate elements for the application that were generated based on a prompt, and include: a) a navigation flow wireframe that identifies a plurality of views for the application, at least some views being selectable to trigger another view from the plurality of views; b) a data model for the application linking underlying logic for the application with a corresponding view from the plurality of views; and c) a user interface skeleton that identifies a representation of how a corresponding view will render content when the application is executed and was generated using a navigation flow plan that indicates transition points between various views from the plurality of views; receiving, via the development user interface of the development system, input data that causes a change to at least one intermediate element from the plurality of intermediate elements; updating, using the input data, the intermediate element from the plurality of intermediate elements; and after updating the intermediate element, causing generation of at least a portion of software code for the application using the navigation flow plan and the plurality of intermediate elements including the updated intermediate element.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the method can include receiving a second prompt to augment the navigation flow wireframe; generating, the second prompt, the prompt, and the navigation flow wireframe, an updated navigation flow wireframe; presenting the updated navigation flow wireframe; and generating a second data model for the application linking underlying logic for the application with a corresponding view from the plurality of views using the second prompt, the prompt and the navigation flow plan.

In some implementations, the method can include receiving data from a second prompt to augment the representation of how the corresponding view will render content when the application is executed; and updating, using the second prompt, the representation of the how the corresponding view will render content when the application is executed for at least some of the views of the plurality of views.

In some implementations, the method can include receiving a request to export the software code for the application; and in response to the request to export the software code for the application: generating any incomplete portions of code representing the intermediate element; and compiling the software code for the application.

In some implementations, updating, using the input data, the intermediate element from the plurality of intermediate elements can include: identifying portions of one or more of a) the navigation flow wireframe, b) a plurality of user interface skeletons including the user interface skeleton, or c) the data model affected by the updates to the intermediate element; and updating the identified portions to integrate with the updated intermediate element.

In some implementations, the method can include for at least some portions of the software code for the application, testing the software code for errors before generating a complete version of the software code for the application.

In some implementations, causing presentation of at least some of the plurality of intermediate elements in the development user interface can include: causing presentation of a design outline that describes aesthetic attributes and structural attributes to use when producing the software code.

In some implementations, the method can include generating, using the prompt, the navigation flow wireframe that identifies the plurality of views for the application, at least some views being selectable to trigger another view from the plurality of views; generating, using the prompt and the navigation flow wireframe, the navigation flow plan that indicates transition points between various views from the plurality of views; generating, using the prompt and the navigation flow plan, the data model for the application linking underlying logic for the application with the corresponding view from the plurality of views; and generating, using the prompt and the navigation flow plan and for each of the plurality of views, a user interface skeleton that identifies the representation of the how the corresponding view will render content when the application is executed.

In some implementations, generating the navigation flow wireframe, the navigation flow plan, the data model, and the user interface skeleton can include: causing generation, based on other changes to other intermediate elements, a modified plurality of intermediate elements including: a modified navigation flow plan; a modified data model; and a modified plurality of user interface skeletons; and causing presentation of at least some of the modified plurality of intermediate elements in the development user interface.

In some implementations, generating, using data from the prompt and the navigation flow plan, the data model for the application linking underlying logic for the application with a corresponding view from the plurality of views can be responsive to input indicating approval of the navigation flow plan.

In some implementations, causing presentation of at least some of the plurality of intermediate elements in the development user interface can include: causing presentation of: a first intermediate element and first proposed portions of software code representing the intermediate element; a prompt requesting feedback on the first intermediate element and the first proposed portions of software code representing the first intermediate element; receiving input; determining, using the input, whether to a) augment the first intermediate element and the first proposed portions of software code representing the intermediate element or b) generate a second intermediate element and second proposed portions of software code representing the intermediate element.

The subject matter described in this specification can be implemented in various implementations and may result in one or more of the following advantages. For example, the development system can reduce the time needed to plan, prototype, or both, a software application when using the intermediate representations described in this specification. This can occur through technological improvements, helping the developer better understanding the code using the intermediate representations, or both. In some examples, the development system can reduce a likelihood of errors in code generation by providing program development prior to code generation, e.g., using the intermediate representations described in this specification. In some examples, the development system can reduce revisions of code in multiple areas of the application by preplanning implementations in a visual layout, e.g., using the navigation flow wireframe, the navigation plan, or both. In some implementations, the development system can test small sections of code iteratively to minimize the time, resources, or both, spent on coding and testing the entire application compared to systems that generate all code for an application at once. In some examples, the development system can enable multiple iterations and improvements to an application plan prior to code generation to reduce resource consumption, time, or both, for code generation for each iteration of planning.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is an example sequence of events for the iterative application generation with LLM that uses IRs.

FIG. 1B is an example generation of the intermediate representations including code for the data model and UI skeleton.

FIG. 1C is an example of a finished runnable application code.

FIG. 2 is an example implementation of the code generation process.

FIG. 3 is a flow diagram of an example process for the system for intermediate representations for iterative application generation.

FIGS. 4A-B are examples of devices and systems for an application programming interface.

FIGS. 5A-D are example processes for an application programming interface.

FIG. 6 is a block diagram of an example computer system that can be used in connection with computer-implemented methods described in this specification.

Like reference numbers and designations in the various drawings indicate like elements.

### DETAILED DESCRIPTION

Some systems can generate code for development of a software application. For instance, a development system can receive a prompt from a developer and generate software code using data for the prompt, e.g., from the prompt or otherwise generated using the prompt. However, such systems do not necessarily have all of the contextual information necessary for generation of an application with a user interface, specifically one with a flow between different views of the user interface.

A development system can receive a prompt from an input device, e.g., which prompt was triggered in response to input from a developer. The development system can generate, using the prompt, one or more intermediate representations (“IRs”) that together represent the application. For instance, a planner can receive the prompt that indicates developer defined features for the application. The planner can determine actions to be performed based on the prompt and generate a query using the prompt and the actions. An artificial intelligence model, such as a large language model (“LLM”), can receive the query as input. The artificial intelligence model can generate one or more additional intermediate representations using the query. The intermediate representations can include a navigation plan, a navigation flow wireframe, a data model for the application, a graphical user interface (“GUI”) skeleton for each view in the navigation flow, or any combination of these. The intermediate representations can include data in a common format, e.g., code, pseudo code, or plain text for a common programming language.

The development system can use one or more of the intermediate representations to present information about the application in a development user interface. For instance, the development system can present a navigation flow wireframe user interface element, a UI skeleton user interface element for each view in the navigation flow, and a data model user interface element. The development system can use the development user interface to receive feedback, via one or more user interface elements, indicating changes to the application. The feedback can be text feedback, e.g., via a text prompt interface element, direct edits to one or more of the navigation flow wireframe, the UI skeleton, or the data model.

The use of intermediate representations can help with the UI development process showing common steps in the process. The use of such intermediate representations can help a developer plan out larger scale projects before code generation. The controlled and iterative process in the planning stages can reduce a likelihood of compounding issues, code compatibility issues, other compounding problems, or any combination of these, caused by adding elements later in the process. For example, it can be easier to design a data model in a planning stage for an application rather than edit a data model already created for an application.

These intermediate representations can be an outline the LLM's code generation process, producing organized and structured code in multiple files while limiting errors. This process can use intermediate representations that reflect typical stages in application development to guide an LLM to generate multi-view apps.

After presentation of some of the IRs, the development system can generate code for the application, e.g., responsive to detecting selection of a code generation interface element or prompting from a developer. As a result, the development system can reduce computational resource usage by waiting to generate code until receiving one or more iterations of feedback on the application.

For instance, intermediate representations can reflect important aspects of the application development process, and can help developers explore design possibilities and communicate their intent to the system. These representations can be used to guide the generation of code that implements a finished application prototype in code, which can be imported into a code development environment for further editing. The generated code can be built in with suitable programming language and the resulting binary can run natively on a device.

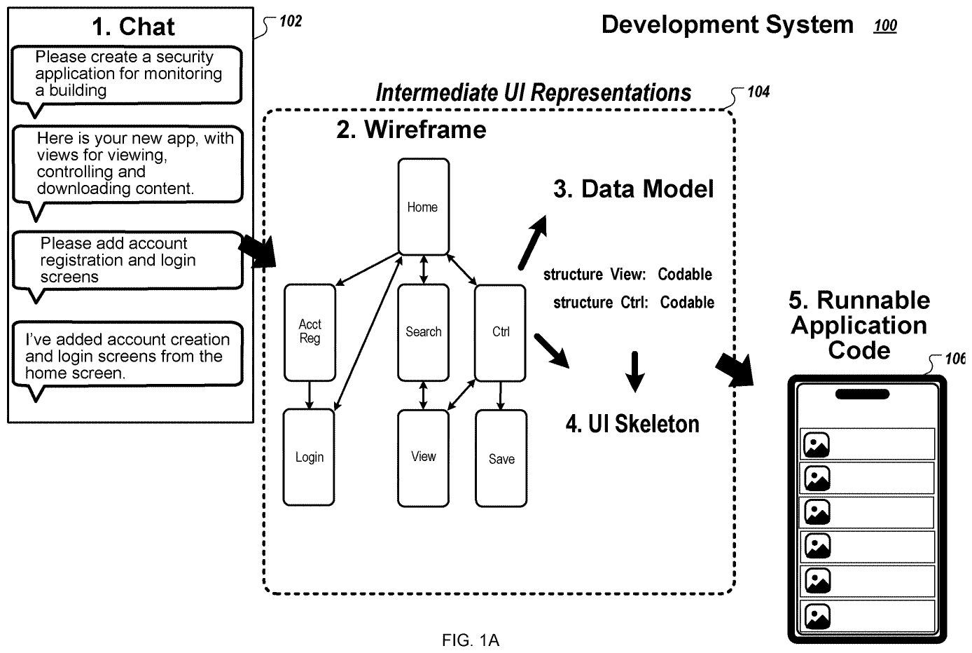

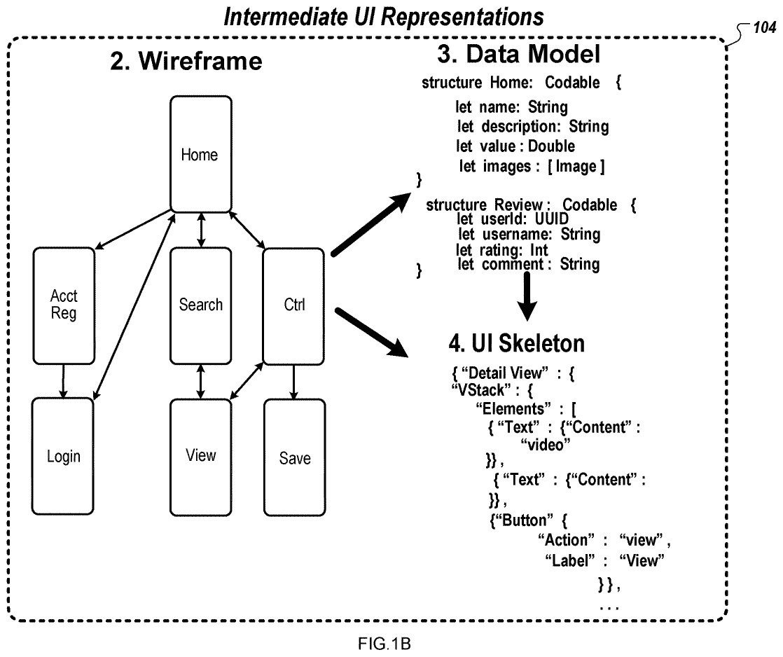

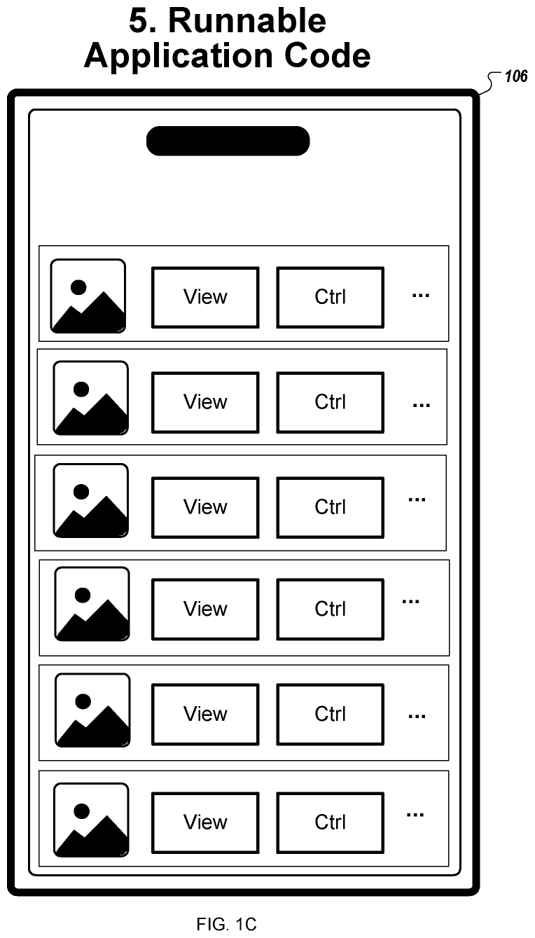

FIG. 1 is an example of a development system 100. The development system 100 can include a developer device, e.g., a computer, used to generate code, execute a large language model (“LLM”), or both. In some instances, the development system 100 can communicate with a remote system that executes the LLM. The development system 100 can execute a sequence of events for the iterative application generation with LLM that uses intermediate representations. FIG. 1 includes the chat 102, the intermediate representations 104, which can include a navigation flow wireframe, a data model, and a UI skeleton, and the runnable application code 106.

The chat 102 can be presented in a user interface on a system, e.g., a chat window in a software development environment. The chat 102 can receive any applicable prompt for generation of an application having multiple, navigable GUIs. For example, the prompt could be: “Please create a data security application tailored specifically for informal community groups to increase data security at their homes. It should allow developers to track network communications, clearly highlight potential issues, and visually display the devices connected to the local network. Let's start with login/sign up flows, application setup, and device connectivity.” In some examples, prompts can be more specific for generation of a portion of the application, such as requesting generation of a home page and login screen. In some examples, a developer can prompt for a specific overview, for example prompting for a home screen that is navigable to a sign-up screen, a login screen, and a menu screen.

The intermediate representations 104 can be generated responsive to prompts in the chat 102. The intermediate representations can include a navigation flow wireframe, a data model, and a UI skeleton. For example, the system can generate a navigation flow wireframe with a reasonable set of proposed screens for the GUI based on the prompt. The system at this point proposed a number of screens for the GUI that would be navigable in an application. If approved by the developer, the system can then generate the supporting code to create an application based on the proposed navigation scheme of GUI screens. In some examples, an iterative process occurs between the developer and the chat 102 to make improvements to the navigation flow wireframe, such as the addition, removal, reconfiguration, or editing of navigable screens to the navigation flow wireframe.

The intermediate representations can be used as building blocks for code. For example, a navigation flow wireframe, data model, and multiple UI skeletons provide an outline of the project for review by a developer before code generation. The intermediate representations represent common incremental design milestones developers encounter when implementing apps: identifying the different views an application should include, the data manipulated between the views, and how the views are rendered.

The navigation flow wireframe can offer a useful outline for a developer to think through the screens of the application at an early stage, and prompt ideation for navigation flows. The navigation flow wireframe can define the structure of the application, represented as a directed graph with each user interface screen for the application as a node represented by a corresponding icon and the navigation paths between screens as edges, e.g., lines, indicated navigational directions between screens. The graph can be represented in code, e.g. in JSON. A screen icon can have an identification number, name, description, a list of outgoing navigational directions with identification numbers of other screens in the navigation flow wireframe, or any combination of these. A screen can have a view name used in development e.g., “login screen”, which is used during code generation to ensure consistent naming across multiple source files.

The edges can be unidirectional or bidirectional. A unidirectional edge indicates that the application can transition from one screen to another in a single direction but not the other. For instance, an edge from the home screen to the account registration screen in the wireframe indicates that the application can transition from the home screen to the account registration screen but not the reverse. A bidirectional edge indicates that the application can transition from either connected screen to the other connected screen. For example, the edge between the home and search screens indicates that the application can transition from the home screen to the search screen or from the search screen to the home screen.

In some examples, the navigation flow wireframe can include more details on the UI design of each screen, such as low fidelity wireframes of UI components. In some examples, a developer can directly manipulate the screens and navigation arrows in the navigation flow wireframe, as opposed to describing the changes that they wanted in text-based chat with the LLM. In some examples, a developer can directly edit the navigation flow wireframe for fine-grained iterations on navigation between views.

For example, the outputted navigation flow wireframe could include a layout of navigable screens responsive to the prompt, but may be lacking a sign-up screen. As a result, the developer requests in a second prompt in chat 102, “Please add sign up to the flow.” At this point, the system can add a sign-up screen to the navigation flow wireframe while keeping the other screens in place. Satisfied with these adjustments, the developer can prompt the system to generate a second and third intermediate representation that can include UI skeletons and data models.

FIG. 1B is an example of the intermediate representations including code for the data model and UI skeleton. As the system iterates in generation of versions of the intermediate representations, the system can, during some the iterations, generate sections of code or other appropriate data such as the UI skeleton and the data model. The UI skeleton can include the code necessary to navigate and link the screens represented in the navigation flow wireframe together. The data model can include code for storing information in the application, retrieve information, receive user input, or any other appropriate use of data in the application. In some examples, the data model can represent information expected to be used in the application. The generation of the data model can be responsive to developer approval of the navigation flow wireframe appearance.

The data model can contain the types of data to be displayed or manipulated by the application, e.g., a book or a restaurant reservation, and can be made up of a set of data entities. Each entity can be represented as a struct in the programming language and may be shared across multiple navigation flow wireframe screens. For example, some entity fields generated by the development system can use primitive types of data fields. Nested entities and more complex types can use more complex data fields. In some examples, data fields can be generated in response to the user prompts. In some examples, data models can reflect data that might be stored in a database or be populated from a web-based data source, while other data models can represent ephemeral data needed to operate a view.

A UI skeleton can specify the content and interactivity of a screen. Each screen present in the navigation flow wireframe can have an associated UI skeleton, can be represented in pseudocode that specifies navigational and structural attributes (e.g., NavigationView and VStack) along with basic UI elements such as Button and Text, or both. In some examples, action handlers, for example on buttons, are represented with strings describing the action to be taken, but not code needed to actually execute the behavior. In some examples, UI skeletons can refer to data entities and their fields to populate UI elements.

In some examples, a developer can directly work with the generated code instead of editing the UI skeleton. For examples, a developer can review the code directly and make edits to the code rather than prompting edits to the code. In some examples, a developer can view a preview of and manipulate the code for the UI throughout the iterative steps.

In some examples, while inspecting how information is represented in data model, the developer can recognize that at least some information is missing. The system can then receive a prompt in the chat 102 to add the field to the data model, which can cause a change in the screen's UI skeleton. Changes to the data model can alter the navigation flow wireframe, the UI skeleton, or both. If a developer is satisfied with the UI skeleton and the data model, the process can move on to generation of code for an executable application.

When the UI skeleton and data models are complete, the system can generate runnable application code 106. For example, the system can generate the graphical representations of the GUI, any necessary images, objects, or supporting material, and the code can be compiled into an executable application. A developer can then review the code and is still able to go back to the system to prompt improvements based on the code. For example, when reviewing the code, a developer may find an error, typo, or other issue. The developer can then return to the chat 102 and prompt the system to improve the UI skeleton, navigation flow wireframe, and data model based on feedback from the code review.

In some examples, when the intermediate representations satisfies a completion criterion, the system can generate the UI views, export them to a programming language project, e.g., for closer inspection, or both. When reviewing code in the programing language preview, the developer can identify a styling improvement for a particular object or function, for example the DrawScheduleView. Returning to the chat, the developer can provide detailed guidance in a prompt: “Please style the schedule view nicely. Add a card for each row with an image for the person's profile pic. Stub it out for now with ‘sf’ symbol. Also, I want to be able to see the person's name, the date of the interaction with the system, their profile pic, and the changes made by the person.”

In response to prompts to edit the data model and UI skeleton, the system can generate a modification plan for all the changes in the request, modify the intermediate representations, update the UI code, or any combination of these. In some examples, the system can iteratively progress through the UI skeleton and update each section. In some examples, the system can show the changes to the developer, for example through underlining or bold font. When a developer is satisfied with the changes, the system can receive input that cause the system to recreate the code for the presentation in a user interface. The process of returning to the chat and entering new prompts can continue as iterative improvements are made.

In some examples, the developer exports again, for another look at the progress of the project. In this example, a prototype application can be complete faster than when developing all of the code at once and debugging and iterating on the large portion of code. The system can provide further additions after approval such as a backend and some custom styling. In some examples, no further additions or refinements are necessary and the developer can prompt the application code to be published.

The use of the example three intermediate representations, the navigation flow wireframe, data model, and UI skeletons, are an example. The system can use more intermediate representations including models that represent interaction with other systems, databases, models, or a combination thereof.

In some examples, a developer can prompt the system to generate code directly after getting a satisfying navigation flow wireframe. In these examples, intermediate representations of data models or UI skeletons may not be created. In some examples, that data model can connect to views of the application where the data model appears, and a developer can click on UI content on each view to navigate to the corresponding data entity within the development system.

FIG. 1C is an example of a finished runnable application code. The runnable application code can be run in an emulator or simulation environment for further refinement and testing. In some examples, the runnable application code is provided for publication as a final application.

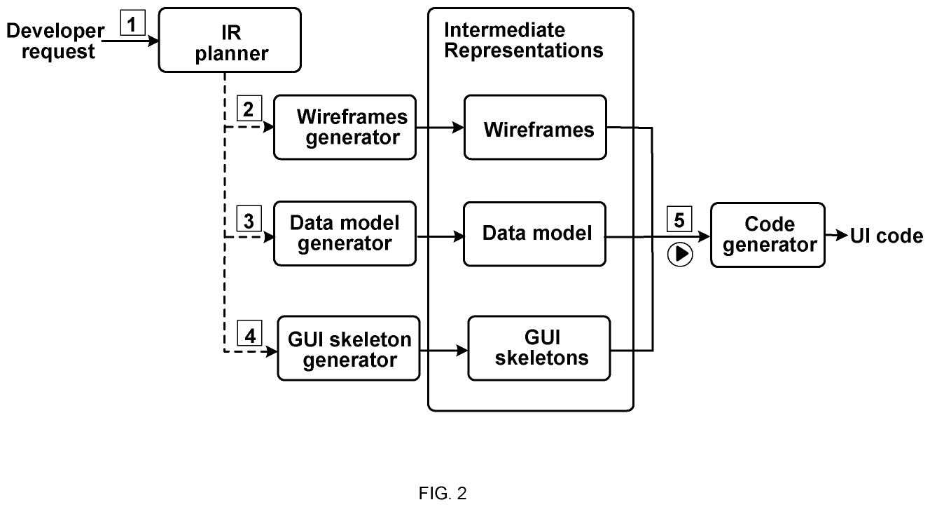

FIG. 2 is an example implementation of the code generation process. The process can start with a system, e.g., the development system 100, receiving a developer request, e.g., a prompt. The system can use LLMs or other appropriate artificial intelligence models through an intermediate representation planner. In some implementations the intermediate representation planner can include a wireframe generator, data model generator, and a UI skeleton generator. The individual generators can run sequentially or in parallel.

Each generator can create their respective output, e.g., the wireframe generator generates wireframes. Each of the outputs can be presented in a user interface in the intermediate representations for review. At various points in the process, the system can receive additional input to refine a portion or all of the generated content. For example, a developer reviewing the wireframes can determine another navigational GUI screen is needed. In this example, the developer can enter a prompt to add the new navigational GUI screen. The system can then use each respective generator to create new or updated outputs that reflect the changes requested in the prompt for each respective output.

Once review is complete, the system can output the intermediate representations into more complete programming language code. In some examples, the system can receive input that indicates selection the outputted code type. In some examples, the system outputs the code into an emulator or simulated environment to test the application. In some examples, the system outputs the code for publishing as a finalize application.

In some examples, when a developer provides a chat message, e.g., a prompt or directly edits the text content of intermediate representations, the system can transmit the changes to a planning prompt engine which determines what changes need to be made to any of the intermediate representations. This approach decomposes the prompt. The planning prompt engine can be prompted to decompose the developer's request, or provided changes, into atomic operations to create, update, or delete navigation flow wireframe views, connections between navigation flow wireframe views, data model entities, and UI skeleton files or representations. In some examples, small requests via a prompt or a developer editing portions the text, such as adding or removing a button from a view, might only require modification of that view's UI skeleton, whereas larger requests may modify multiple intermediate representations.

In some examples, prior to the creation of a first version of each intermediate representation based on the developer's initial prompt, a navigation plan is created. In some examples, the navigation plan describes the overall navigation design for the application based on the initial generated navigation flow wireframe. In these examples, the navigation plan can be provided as an input to the creation of each initial UI skeleton. After the initial UI skeletons are constructed, the system can discard the navigation plan. In some examples, the system can maintain the navigation plan for later use.

In the above example, after the plan is produced, the intermediate representations are each modified. The modification can be sequentially in an order that takes into account the dependencies between the representations. For example, the navigation flow wireframe can be modified first, followed by the data model, and then any affected UI skeletons. In some examples, the system shows the changes to each portion of the intermediate representations in a user interface through, highlights, notes, or any equivalent visual representation of the changes.

For example, navigation flow wireframe modification can be done by prompting with a current navigation flow wireframe displayed. The prompt can add or remove changes requested by the produced plan. Additions, removals, and changes in edges, e.g., navigational directions between UI screens, can be processed in a single call to an LLM, to the system, or by multiple calls to different LLMs or subcomponents of the system, e.g., sub-LLMs. In some examples, future removals and navigational directions between UI screens changes, from future prompts, might be implemented by tools that change the internal data structure directly without requiring an LLM. In some examples, additions can require an LLM to fill in a name and description, and ensure navigational directions between UI screens across the navigation flow wireframe are appropriately modified to include the new addition. In some examples, each change can be independent of the others and the changes can be processed with parallel LLM calls to speed up processing.

In some examples, data model modification can follow navigation flow wireframe modification and can be implemented in a similar way. For example, for each change specified by the plan, an LLM is prompted with the current navigation flow wireframe, current data model, and the requested change. The LLM can return an updated data model based on the current intermediate representations and the prompt. In some example. All changes can be processed in one LLM call. In some examples, some changes can be processed by a tool without requiring an LLM, or can require multiple LLMs. In some examples, each change can be independent of the others and the changes can be processed with parallel LLM calls to speed up processing.

In some examples, UI skeleton modification can follow navigation flow wireframe and data model changes. For example, in some developing applications the skeletons are dependent on both the navigation flow wireframe and the data model. In these examples, for each change specified by the plan, an LLM can be prompted with the current navigation flow wireframe, data model, UI skeleton and the requested change, and can return a modified UI skeleton. In these examples, each UI skeleton can be independent of the others and the changes can be processed with parallel LLM calls to speed up processing.

In some examples, the intermediate representations have dependencies on each other. For example, the navigation flow wireframe can define each of the UI screens that are present in the application and a UI skeleton can be generated for each screen. As the navigation flow wireframe is updated, based on further prompting from the developer, the UI skeletons can be updated as well. In some examples, the UI skeletons can be dependent on the data model and can name entities and fields that exist. In these examples, the dependencies affect the order in which the intermediate representations are modified.

In some examples, a single LLM call is used to generate all of the necessary code, which takes all of the intermediate representations as input, and produces all of the output files encoded in an appropriate coding format, e.g., a JSON format, that can be parsed and placed into a typical UI file structure. In some examples, a single call is used. In some examples, multiple calls can be used to generate all views simultaneously from separate LLM calls. In some examples, a sequence of calls can be used e.g., ordering the code generation using a post-order traversal of the views so that child views are generated first and parent views are generated with knowledge of their children's code.

In some examples, when prompted to create the code, the system can create a design outline for the code. Generation of a design outline for the code can improve the quality of UI code generation because the intermediate step allows for developer review prior to code generation. The code design outline can describe colors, fonts, navigation and other aesthetic and structural attributes to use while producing the code. In some examples, the design outline can be modifiable by the developer directly or through prompts. In some examples, the design outline is generated by an LLM using a prompt from the initial query made by the developer. In some examples, the design outline can be approved and the developer can prompt generation of the code. After the code is generated, it can be imported into a project, built, and run on a local or simulated device.

In some examples, the system can run error detection and correction prior to or after creation of code. For example, the system can update portions of the code, navigation flow wireframe, data model, or UI skeleton based on a developer prompt and perform a code error check. In some examples, prior to generating complete code for exporting to a testing environment, the system can perform an error check on the code. The errors found can be presented in a user interface, e.g., for review or corrected by the system and the correction reported to the developer.

The development system is an example of a system implemented as computer programs on one or more computers in one or more locations, in which the systems, components, and techniques described in this specification are implemented. The development system can receive input directly from a developer, e.g., via keyboard, mouse, voice input, another appropriate input type, or any combination of these. In some instances, the development system can receive input from a client device. The client devices can include personal computers, mobile communication devices, and other devices that can send and receive data over a network. The network (not shown), such as a local area network (“LAN”), wide area network (“WAN”), the Internet, or a combination thereof, can connect the client devices, the development system, and the other supporting systems, e.g., an application store or other source by which downstream devices can download code for installation. The development system can use a single computer or multiple computers operating in conjunction with one another, including, for example, a set of remote computers deployed as a cloud computing service.

The development system can include several different functional components, including a UI skeleton generator, a data model generator, a navigation flow wireframe generator, one or more code generators, or a combination thereof. Any one or more of the components can include one or more data processing apparatuses, can be implemented in code, or a combination of both. For instance, each of the components can include one or more data processors and instructions that cause the one or more data processors to perform the operations discussed in this specification.

The various functional components of the development system can be installed on one or more computers as separate functional components or as different modules of the same functional component. For example, the components UI skeleton generator and data model generator of the development system can be implemented as computer programs installed on one or more computers in one or more locations that are coupled to each through a network. In cloud-based systems for example, these components can be implemented by individual computing nodes of a distributed computing system.

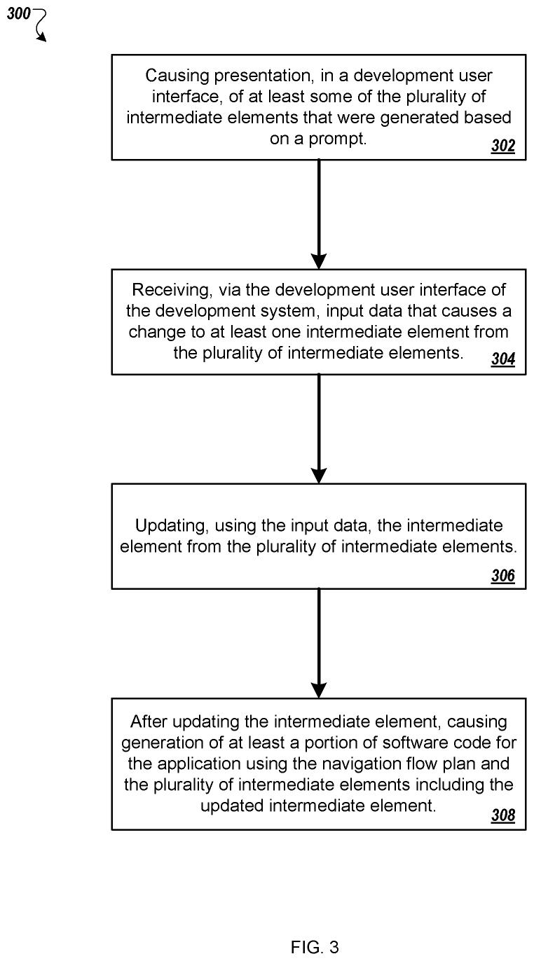

FIG. 3 is a flow diagram of an example process 300 for the system for intermediate representations for iterative application generation. For example, the process 300 can be used by a development system for presentation of a plurality of intermediate elements of an application.

The process can include causing presentation, in a development user interface, of at least some of the plurality of intermediate elements that were generated based on a prompt 302. In some examples, the intermediate elements can include a) a navigation flow wireframe that identifies a plurality of views for the application, at least some views being selectable to trigger another view from the plurality of views; b) a data model for the application linking underlying logic for the application with a corresponding view from the plurality of views and was generated using a navigation flow plan that indicates transition points between various views from the plurality of views; and c) a user interface skeleton that identifies a representation of how a corresponding view will render content when the application is executed and was generated using the navigation flow plan. For example, the plurality of views of the application can be visual representations of each GUI screen a user would see in a finished application. In some examples, the visual representations are simple labels providing a rough outline of the navigational flow of the application. In some examples, the data model can represent the data used by the application. For example, the data models can include data presented to the user, data received from the user, data associated with the user, or a combination thereof. In some examples, a user interface skeleton can include visual representations of how the GUI will present in the completed application. For example, the user interface skeleton can include logos, colors, font, and other elements of the visual representation of the user interface.

The process can include receiving, via the development user interface of the development system, input data that causes a change to at least one intermediate element from the plurality of intermediate elements 304. For example, a user can review portions of the output, e.g., the navigation flow wireframe, and decide more navigation flow wireframe representations should be added or some of the navigation flow wireframe representations should be removed. For example, the user can prompt the development system to add more navigation flow wireframe representations. In some examples, the user can prompt the development system to add more information to the data model for presentation to the user in the final application. Each of the prompts can be entered at any point in the process to further refine the navigation flow wireframe, data model, UI skeleton, code, or a combination thereof.

The process can include updating, using the input data, the intermediate element from the plurality of intermediate elements 306. For example, the prompt can cause the development system to alter the navigation flow wireframe by adding, removing, or editing portions of the navigation flow wireframe. In some implementations, the prompt can cause cascading changes. For example, the addition of a navigation flow wireframe element can cause additions to the data model and UI skeleton.

The process can include after updating the intermediate element, causing generation of at least a portion of software code for the application using the navigation flow plan and the plurality of intermediate elements including the updated intermediate element 308. For example, the development system can update various portions of the process depending on how many intermediate elements have been generated. In these examples, if the data models and UI skeleton have been generated, but the code has not yet been generated, the development system can update the navigation flow wireframe, data models, and UI skeleton, but not update or generate code. In some examples, if the code has been generated, prompted changes can propagate through the navigation flow wireframe, data model, UI skeleton, and code.

The order of operations in the process 300 described above is illustrative only, and development system can be performed in different orders. For instance, the process 300 can receive the input data (operation 304) and update at least one intermediate element (operation 306) and then cause presentation of that updated intermediate element (operation 302).

In some implementations, the process 300 can include additional operations, fewer operations, or some of the operations can be divided into multiple operations. For example, the development system can generate portions of the user interface such as color schemes, logos, images, or a combination thereof. For example, the development system can use a prompt to create a navigation flow wireframe and UI skeleton after a first prompt. In some examples, the development system creates only the navigation flow wireframe and does not generate further content until a user approves the navigation flow wireframe. In some examples, the development system can generate the data model without generating the UI skeleton or vice versa. In some examples, the user can direct specific elements to be generated using the prompt.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

In this specification, the term “database” can broadly refer to any collection of data: the data does not need to be structured in any particular way, or structured at all, and it can be stored on storage devices in one or more locations. A database can be implemented on any appropriate type of memory.

In this specification the term “engine” or “generator” can broadly refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

In this specification, the term likely can mean that there is a likelihood that something might occur and that the likelihood satisfies a likelihood threshold. For instance, when determining that code is likely to improve the performance of an application, a system would determine a likelihood that the code would improve the performance of the application. The system would then determine whether the likelihood satisfies, e.g., is greater than or equal to, a likelihood threshold by comparing the two values. If so, the system determines that the code is likely to improve the performance of the application. If not, the system determines that the code is not likely to improve the performance of the application.

Operations can occur substantially concurrently in that the operations need not be exactly concurrent but can overlap at least in part. For instance, a first operation can begin and sometime after that a second operation can begin while the first operation is still occurring. Execution of the two operations, whether by the same system or different systems, can be substantially concurrent. In some examples, two operations can execute substantially concurrently when they have the same start time, same end time, or both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

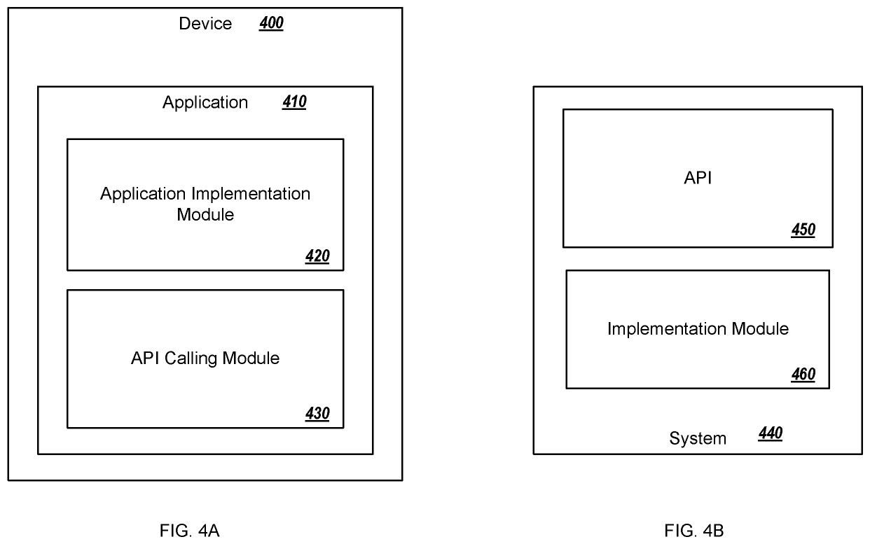

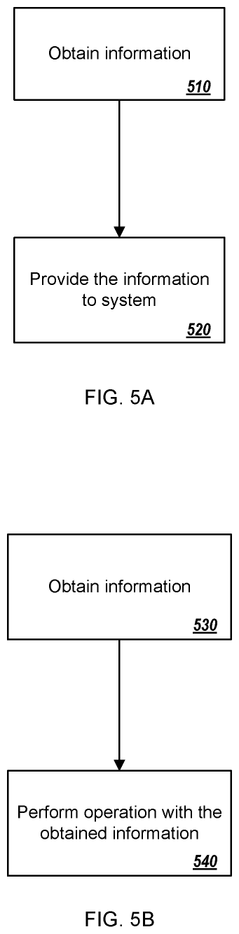

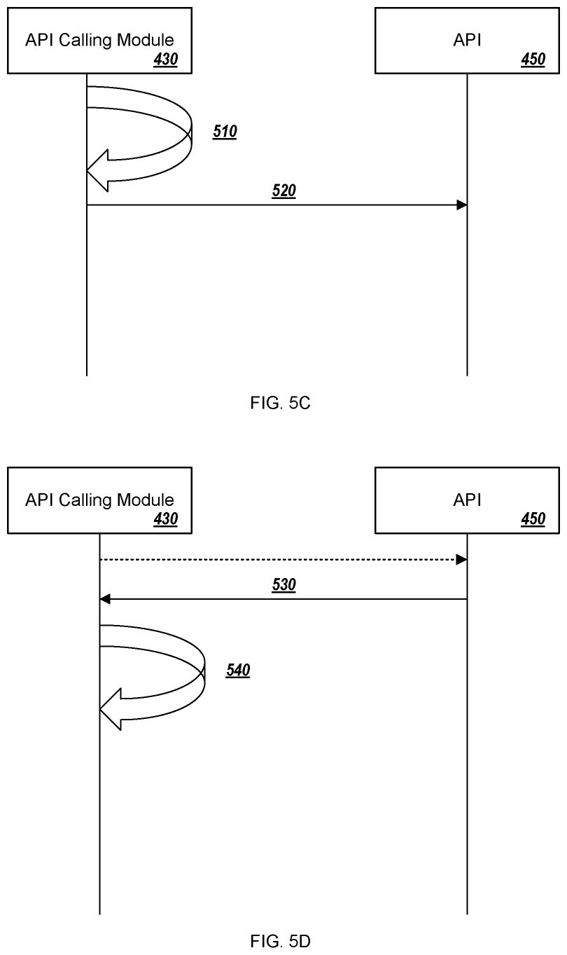

Implementations within the scope of the present disclosure include a computer-readable storage medium that encodes instructions organized as an application (e.g., application 410 shown in FIG. 4A) that, when executed by one or more processing units, control an electronic device (e.g., device 400 shown in FIG. 4A) to perform any of the methods of FIG. 5A-D, and/or one or more other processes and/or methods described herein.

It should be recognized that application 410 (shown in FIG. 4A) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 410 is an application that is pre-installed on device 400 at purchase (e.g., a first party application). In other embodiments, application 410 is an application that is provided to device 400 via an operating system update file (e.g., a first party application or a second party application). In some embodiments, application 410 is an application that is provided via an application store. In some embodiments, the application store can be an application store that is pre-installed on device 400 at purchase (e.g., a first party application store). In some embodiments, the application store is a third-party application store (e.g., an application store that is provided by another application store, downloaded via a network, and/or read from a storage device).

Referring to FIG. 5A and FIG. 5C, application 410 obtains information (e.g., 510). In some embodiments, at 510, information is obtained from at least one hardware component of the device 400. In some embodiments, at 510, information is obtained from at least one software module (e.g., set of instructions) of the device 400. In some embodiments, at 510, information is obtained from at least one hardware component external to the device 400 (e.g., a peripheral device, an accessory device, and/or a server). In some embodiments, the information obtained at 510 includes positional information, time information, notification information, user information, environment information, electronic device state information, weather information, media information, historical information, event information, hardware information, and/or motion information. In some embodiments, in response to and/or after obtaining the information at 510, application 410 provides the information to a system (e.g., 520), e.g., using an API 450.

In some embodiments, the system (e.g., 440 shown in FIG. 4B) is an operating system hosted on the device 400. In some embodiments, the system (e.g., 440 shown in FIG. 4B) includes one or more external devices (e.g., a server, a peripheral device, an accessory, and/or a personal computing device) that includes an operating system.

Referring to FIG. 5B and FIG. 5D, application 410 obtains information (e.g., 530). The application 410 can obtain the information from the system 440, e.g., using the API 450. In some embodiments, the information obtained at 530 includes positional information, time information, notification information, user information, environment information electronic device state information, weather information, media information, historical information, event information, hardware information and/or motion information. In response to and/or after obtaining the information at 530, application 410 performs an operation with the information (e.g., 540). In some embodiments, the operation performed at 540 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 440 based on the information.

In some embodiments, one or more steps of the method of FIG. 5A and/or the method of FIG. 5B is performed in response to a trigger. In some embodiments, the trigger includes detection of an event, a notification received from system 440, a user input, and/or a response to a call to an API provided by system 440.

In some embodiments, the instructions of application 410, when executed, control device 400 to perform the method of FIG. 5A and/or the method of FIG. 5B by calling an application programming interface (API) (e.g., API 450) provided by system 440. In some embodiments, application 410 performs at least a portion of the method of FIG. 5A and/or the method of FIG. 5B without calling API 450.

In some embodiments, one or more steps of the method of FIG. 5A and/or the method of FIG. 5B includes calling an API (e.g., API 450) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 4A, device 400 is illustrated. In some embodiments, device 400 is a personal computing device, a smart phone, a smart watch, a fitness tracker, a head mounted display (HMD) device, a media device, a communal device, a speaker, a television, and/or a tablet. Device 400 includes application 410 and an operating system (not shown) (e.g., system 440 shown in FIG. 4B). Application 410 includes application implementation module 420 and API calling module 430. The API calling module 430 can implement instructions for accessing the API 450. System 440 includes API 450 and implementation module 460. The implementation module 460 can include one or more instructions that implement a corresponding software application. It should be recognized that device 400, application 410, and/or system 440 can include more, fewer, and/or different components than illustrated in FIGS. 4A and 4B.

In some embodiments, application implementation module 420 is a software module that includes a set of one or more computer-readable instructions. In some embodiments, the set of one or more instructions correspond to one or more operations performed by application 410. For example, when application 410 is a messaging application, application implementation module 420 can include instructions to execute operations to receive and send messages. In some embodiments, application implementation module 420 communicates with API calling module 430 to communicate with system 440 via API 450 (shown in FIG. 4B).

In some embodiments, API calling module 430 is a software module that includes a set of one or more computer-executable instructions. The instructions can enable the API calling module 430 to communicate with the API 450, e.g., can include instructions that call one or more functions defined by the API 450.

In some embodiments, implementation module 460 is a software module that includes a set of one or more computer-executable instructions.

In some embodiments, API 450 is a software module that includes a set of one or more computer-executable instructions. In some embodiments, API 450 provides an interface that allows a different set of instructions (e.g., API calling module 430) to access and/or use one or more functions, methods, procedures, data structures, classes, and/or other services provided by implementation module 460 of system 440. For example, API-calling instructions 430 can access a feature of implementation module 460 through one or more API calls or invocations (e.g., embodied by a function or a method call) exposed by API 450 and can pass data and/or control information using one or more parameters via the API calls or invocations. In some embodiments, API 450 allows application 410 to use a service provided by a Software Development Kit (SDK) library, e.g., on the system 440. In some embodiments, application 410 incorporates a call to a function or method provided by the SDK library and provided by API 450, uses data types or objects defined in the SDK library and provided by API 450, or a combination of both. In some embodiments, API calling module 430 makes an API call via API 450 to access and use a feature of implementation module 460 that is specified by API 450. In such embodiments, implementation module 460 can return a value via API 450 to API calling module 430 in response to the API call. The value can report to application 410 the capabilities or state of a hardware component of device 400, including those related to aspects such as input capabilities and state, output capabilities and state, processing capability, power state, storage capacity and state, and/or communications capability. In some embodiments, API 450 is implemented in part by firmware, microcode, or other low-level logic that executes in part on the hardware component.

In some embodiments, API 450 allows a developer of API calling module 430 (which can be a third-party developer) to leverage a feature provided by implementation module 460. In such embodiments, there can be one or more set of API calling instructions (e.g., included in API calling module 430) that communicate with implementation module 460. In some embodiments, API 450 allows multiple sets of API calling instructions written in different programming languages to communicate with implementation module 460 (e.g., API 450 can include features for translating calls and returns between implementation module 460 and API calling module 430) while API 450 is implemented in terms of a specific programming language. In some embodiments, API calling module 430 calls APIs from different providers such as a set of APIs from an operating system (“OS”) provider, another set of APIs from a plug-in provider, and/or another set of APIs from another provider (e.g., the provider of a software library) or creator of the another set of APIs.

Examples of API 450 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 400. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 460 is a system (e.g., operating system, server system) software module (e.g., a collection of computer-readable instructions) that is constructed to perform an operation in response to receiving an API call via API 450. In some embodiments, implementation module 460 is constructed to provide an API response (via API 450) as a result of processing an API call. By way of example, implementation module 460 and API-calling instructions 430 can each be any one of an operating system, a library, a device driver, an API, an application program, or other module. It should be understood that implementation module 460 and API calling module 430 can be the same or different type of software module from each other. In some embodiments, implementation module 460 is embodied at least in part in firmware, microcode, or other hardware logic, e.g., of the system 440.

In some embodiments, implementation module 460 returns a value through API 450 in response to an API call from API calling module 430. While API 450 defines the syntax and result of an API call (e.g., how to invoke the API call and what the API call does), API 450 might not reveal how implementation module 460 accomplishes the function specified by the API call. Various API calls are transferred via the one or more application programming interfaces between API calling module 430 and implementation module 460. Transferring the API calls can include issuing, initiating, invoking, calling, receiving, returning, and/or responding to the function calls or messages. In other words, transferring can describe actions by either of API calling module 430 or implementation module 460. In some embodiments, a function call or other invocation of API 450 sends and/or receives one or more parameters through a parameter list or other structure.

In some embodiments, implementation module 460 provides more than one API, each providing a different view of or with different aspects of functionality implemented by implementation module 460. For example, one API of implementation module 460 can provide a first set of functions and can be exposed to third party developers, and another API of implementation module 460 can be hidden (e.g., not exposed) and provide a subset of the first set of functions and also provide another set of functions, such as testing or debugging functions which are not in the first set of functions. In some embodiments, implementation module 460 calls one or more other components via an underlying API and thus be both a set of API calling module instructions and a set of implementation module instructions. It should be recognized that implementation module 460 can include additional functions, methods, classes, data structures, and/or other features that are not specified through API 450 and are not available to API calling module 430. It should also be recognized that API calling module 430 can be on the same system as implementation module 460 or can be located remotely and access implementation module 460 using API 450 over a network. In some embodiments, implementation module 460, API 450, and/or API calling module 430 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, the user interface code generation is performed at a first computer system (as described herein) via a system process (e.g., an operating system process, a server system process) that is different from one or more applications executing and/or installed on the first computer system.

In some embodiments, the user interface code generation is performed at a first computer system (as described herein) by an application that is different from a system process. In some embodiments, the instructions of the application, when executed, control the first computer system to perform the user interface code generation by calling an application programming interface (API) provided by the system process. In some embodiments, the application performs at least a portion of the user interface code generation without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an application that is provided by an application store, downloaded via a network, and/or read from a storage device).

In some embodiments, the application is a third party application (e.g., an application that is provided by an application store, downloaded via a network, and/or read from a storage device). In some embodiments, the application controls the first computer system to perform a the user interface code generation by calling an application programming interface (API) provided by the system process using one or more parameters.

In some embodiments, at least one API is a software module (e.g., a collection of computer-readable instructions) that provides an interface that allows a different set of instructions (e.g., API calling module) to access and use one or more functions, methods, procedures, data structures, classes, and/or other services provided by a set of implementation instructions of the system process. The API can define one or more parameters that are passed between the API calling module and the implementation instructions.

As described above, in some embodiments, the application controls the first computer system to perform the user interface code generation by calling an application programming interface (API) provided by the system process using one or more parameters.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 400) that runs the application. In some embodiments, the set of implementation instructions is included in an electronic device that is separate from the device that runs the application.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a client device, e.g., for purposes of displaying data to and receiving user input from a client device, which acts as a client. Data generated at the client device, e.g., a result of user interaction with the client device, can be received from the client device at the server.

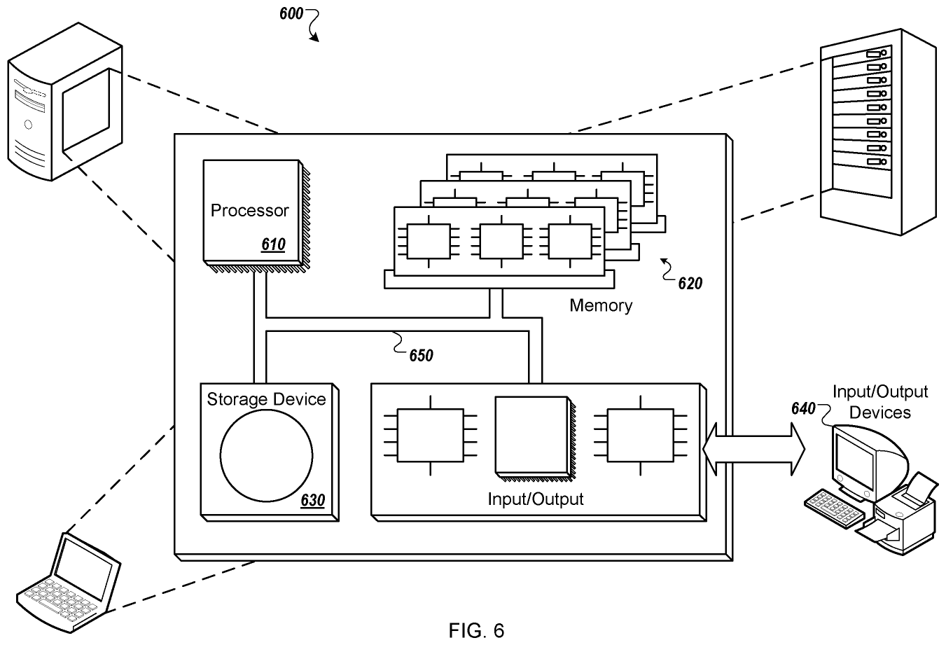

FIG. 6 is a block diagram of an example computer system 600. For example, the computer systems, whether used by a person, backend systems, cloud computing systems, or any combination of these, described in this specification could be an example of the system 600 described here. The system 600 includes a processor 610, a memory 620, a storage device 630, and one or more input/output interface devices 640. Each of the components 610, 620, 630, and 640 can be interconnected, for example, using a system bus 650.

The processor 610 is capable of processing instructions for execution within the system 600. The term “execution” as used here refers to a technique in which program code causes a processor to carry out one or more processor instructions. In some implementations, the processor 610 is a single-threaded processor. In some implementations, the processor 610 is a multi-threaded processor. In some implementations, the processor 610 is a quantum computer. The processor 610 is capable of processing instructions stored in the memory 620 or on the storage device 630. The processor 610 may execute operations such as those described elsewhere in this specification.

The memory 620 stores information within the system 600. In some implementations, the memory 620 is a computer-readable medium. In some implementations, the memory 620 is a volatile memory unit. In some implementations, the memory 620 is a non-volatile memory unit.

The storage device 630 is capable of providing mass storage for the system 600. In some implementations, the storage device 630 is a non-transitory computer-readable medium. In various different implementations, the storage device 630 can include, for example, a hard disk device, an optical disk device, a solid-state drive, a flash drive, magnetic tape, or some other large capacity storage device. In some implementations, the storage device 630 may be a cloud storage device, e.g., a logical storage device including one or more physical storage devices distributed on a network and accessed using a network, such as any networks shown in the figures. In some examples, the storage device may store long-term data, such as one or more of the various types of data described in this specification. The input/output interface devices 640 provide input/output operations for the system 600. In some implementations, the input/output interface devices 640 can include one or more of a network interface devices, e.g., an Ethernet interface, a serial communication device, e.g., an RS-232 interface, and/or a wireless interface device, e.g., an 802.11 interface, a 4G wireless modem, a 5G wireless modem, etc. A network interface device allows the system 600 to communicate, for example, transmit and receive data such as one or more of the various types of data described in this specification. In some implementations, the input/output device can include driver devices configured to receive input data and send output data to other input/output devices, e.g., keyboard, printer and display devices 660. In some implementations, mobile computing devices, mobile communication devices, and other devices can be used.

In some examples, the system 600 is contained within a single integrated circuit package. A system 600 of this kind, in which both a processor 610 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 640.

Although an example processing system has been described in with reference to various figures throughout this specification, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. Sometimes a server (e.g., that implements a database or otherwise) is a general purpose computer, and sometimes it is a custom-tailored special purpose electronic device, and sometimes it is a combination of these things.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

In some implementations, when a device or system transmits data to another device or system, the transmission of the data, such as a message, can cause the other device or system to perform one or more actions. For instance, transmission of a message that includes an instruction to a camera can cause the camera to capture one or more images, transmit one or more images to the device or system, or a combination of both.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (“AI”) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly), e.g., to a person.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (“LLMs”). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning (“ML”) systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to, data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In some implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In some examples, the present technology should be configured to allow users to select not to provide certain data for training the AI/ML systems and/or for use as input during the inference stage of such systems. In some examples, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A development system for presentation of a plurality of intermediate elements of an application and comprising one or more computers and one or more storage devices on which are stored instructions that are operable, when executed by the one or more computers, to cause the one or more computers to perform operations comprising:
causing presentation, in a development user interface, of at least some of the plurality of intermediate elements for the application that were generated based on a prompt, and comprise:
a) a navigation flow wireframe that identifies a plurality of views for the application, at least some views being selectable to trigger another view from the plurality of views;
b) a data model for the application linking underlying logic for the application with a corresponding view from the plurality of views; and
c) a user interface skeleton that identifies a representation of how a corresponding view will render content when the application is executed and was generated using a navigation flow plan that indicates transition points between various views from the plurality of views;
receiving, via the development user interface of the development system, input data that causes a change to at least one intermediate element from the plurality of intermediate elements;
updating, using the input data, the intermediate element from the plurality of intermediate elements; and
after updating the intermediate element, causing generation of at least a portion of software code for the application using the navigation flow plan and the plurality of intermediate elements including the updated intermediate element.

2. The system of claim 1, the operations comprising:
receiving a second prompt to augment the navigation flow wireframe;
generating, the second prompt, the prompt, and the navigation flow wireframe, an updated navigation flow wireframe;
presenting the updated navigation flow wireframe; and
generating a second data model for the application linking underlying logic for the application with a corresponding view from the plurality of views using the second prompt, the prompt and the navigation flow plan.

3. The system of claim 1, the operations comprising:
receiving data from a second prompt to augment the representation of how the corresponding view will render content when the application is executed; and
updating, using the second prompt, the representation of the how the corresponding view will render content when the application is executed for at least some of the views of the plurality of views.

4. The system of claim 1, the operations comprising:
receiving a request to export the software code for the application; and
in response to the request to export the software code for the application:
generating any incomplete portions of code representing the intermediate element; and
compiling the software code for the application.

5. The system of claim 1, wherein updating, using the input data, the intermediate element from the plurality of intermediate elements comprises:
identifying portions of one or more of a) the navigation flow wireframe, b) a plurality of user interface skeletons including the user interface skeleton, or c) the data model affected by the updates to the intermediate element; and
updating the identified portions to integrate with the updated intermediate element.

6. The system of claim 1, the operations comprising:
for at least some portions of the software code for the application, testing the software code for errors before generating a complete version of the software code for the application.

7. The system of claim 1, wherein causing presentation of at least some of the plurality of intermediate elements in the development user interface comprises:
causing presentation of a design outline that describes aesthetic attributes and structural attributes to use when producing the software code.

8. The system of claim 1, the operations comprising:
generating, using the prompt, the navigation flow wireframe that identifies the plurality of views for the application, at least some views being selectable to trigger another view from the plurality of views;
generating, using the prompt and the navigation flow wireframe, the navigation flow plan that indicates transition points between various views from the plurality of views;
generating, using the prompt and the navigation flow plan, the data model for the application linking underlying logic for the application with the corresponding view from the plurality of views; and
generating, using the prompt and the navigation flow plan and for each of the plurality of views, a user interface skeleton that identifies the representation of the how the corresponding view will render content when the application is executed.

9. The system of claim 8, wherein generating the navigation flow wireframe, the navigation flow plan, the data model, and the user interface skeleton comprises:
causing generation, based on other changes to other intermediate elements, a modified plurality of intermediate elements comprising:
a modified navigation flow plan;
a modified data model; and
a modified plurality of user interface skeletons; and
causing presentation of at least some of the modified plurality of intermediate elements in the development user interface.

10. The system of claim 8, wherein generating, using data from the prompt and the navigation flow plan, the data model for the application linking underlying logic for the application with a corresponding view from the plurality of views is responsive to input indicating approval of the navigation flow plan.

11. The system of claim 1, wherein causing presentation of at least some of the plurality of intermediate elements in the development user interface comprises:
causing presentation of:
a first intermediate element and first proposed portions of software code representing the intermediate element;
a prompt requesting feedback on the first intermediate element and the first proposed portions of software code representing the first intermediate element;
receiving input;
determining, using the input, whether to a) augment the first intermediate element and the first proposed portions of software code representing the intermediate element or b) generate a second intermediate element and second proposed portions of software code representing the intermediate element

12. A computer-implemented method comprising:
causing presentation, in a development user interface, of at least some of the plurality of intermediate elements for the application that were generated based on a prompt, and comprise:
a) a navigation flow wireframe that identifies a plurality of views for the application, at least some views being selectable to trigger another view from the plurality of views;
b) a data model for the application linking underlying logic for the application with a corresponding view from the plurality of views; and
c) a user interface skeleton that identifies a representation of how a corresponding view will render content when the application is executed and was generated using a navigation flow plan that indicates transition points between various views from the plurality of views;
receiving, via the development user interface of the development system, input data that causes a change to at least one intermediate element from the plurality of intermediate elements;
updating, using the input data, the intermediate element from the plurality of intermediate elements; and
after updating the intermediate element, causing generation of at least a portion of software code for the application using the navigation flow plan and the plurality of intermediate elements including the updated intermediate element.

13. The method of claim 12, comprising:
receiving a second prompt to augment the navigation flow wireframe;
generating, the second prompt, the prompt, and the navigation flow wireframe, an updated navigation flow wireframe;
presenting the updated navigation flow wireframe; and
generating a second data model for the application linking underlying logic for the application with a corresponding view from the plurality of views using the second prompt, the prompt and the navigation flow plan.

14. The method of claim 12, comprising:
receiving data from a second prompt to augment the representation of how the corresponding view will render content when the application is executed; and
updating, using the second prompt, the representation of the how the corresponding view will render content when the application is executed for at least some of the views of the plurality of views.

15. The method of claim 12, comprising:
receiving a request to export the software code for the application; and
in response to the request to export the software code for the application:
generating any incomplete portions of code representing the intermediate element; and
compiling the software code for the application.

16. The method of claim 12, wherein updating, using the input data, the intermediate element from the plurality of intermediate elements comprises:
identifying portions of one or more of a) the navigation flow wireframe, b) a plurality of user interface skeletons including the user interface skeleton, or c) the data model affected by the updates to the intermediate element; and
updating the identified portions to integrate with the updated intermediate element.

17. The method of claim 12, comprising:
for at least some portions of the software code for the application, testing the software code for errors before generating a complete version of the software code for the application.

18. The method of claim 12, wherein causing presentation of at least some of the plurality of intermediate elements in the development user interface comprises:
causing presentation of a design outline that describes aesthetic attributes and structural attributes to use when producing the software code.

19. The method of claim 12, comprising:
generating, using the prompt, the navigation flow wireframe that identifies the plurality of views for the application, at least some views being selectable to trigger another view from the plurality of views;
generating, using the prompt and the navigation flow wireframe, the navigation flow plan that indicates transition points between various views from the plurality of views;
generating, using the prompt and the navigation flow plan, the data model for the application linking underlying logic for the application with the corresponding view from the plurality of views; and
generating, using the prompt and the navigation flow plan and for each of the plurality of views, a user interface skeleton that identifies the representation of the how the corresponding view will render content when the application is executed.

20. One or more computer storage media encoded with instructions that, when executed by one or more computers, cause the one or more computers to perform operations comprising:
causing presentation, in a development user interface, of at least some of the plurality of intermediate elements for the application that were generated based on a prompt, and comprise:
a) a navigation flow wireframe that identifies a plurality of views for the application, at least some views being selectable to trigger another view from the plurality of views;
b) a data model for the application linking underlying logic for the application with a corresponding view from the plurality of views; and
c) a user interface skeleton that identifies a representation of how a corresponding view will render content when the application is executed and was generated using a navigation flow plan that indicates transition points between various views from the plurality of views;
receiving, via the development user interface of the development system, input data that causes a change to at least one intermediate element from the plurality of intermediate elements;
updating, using the input data, the intermediate element from the plurality of intermediate elements; and
after updating the intermediate element, causing generation of at least a portion of software code for the application using the navigation flow plan and the plurality of intermediate elements including the updated intermediate element.
